(19) United States
(12) Patent Application Publication
(10) Pub. No.: US 2010/0251934 A1
(43) Pub. Date: Oct. 7, 2010

(54) MODELING COMPOUNDS AND METHOD OF MAKING SAME

(76) Inventor: Kimberly L. Smith, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 12/754,463

(22) Filed: Apr. 5, 2010

Related U.S. Application Data
(60) Provisional application No. 61/166,600, filed on Apr. 3, 2009.

(51) Int. Cl. C08L 89/00; C08L 5/12; C08L 5/04; C08L 5/06; C08L 1/00

(52) U.S. Cl. 106/125.1; 106/205.01; 106/163.01; 106/244

(57) ABSTRACT

The present invention provides modeling compounds and methods of making such compounds. In addition to other desirable properties, these modeling compounds may be certified organic, gluten-free, and/or soy-free.

### CROSS-REFERENCE TO RELATED APPLICATION

This application claims the benefit of U.S. Provisional Application No. 61/166,600, filed Apr. 3, 2009, which is incorporated herein by reference in its entirety.

### FIELD OF THE INVENTION

The invention relates generally to flexible modeling compounds that can be used for molding, rolling, or sculpting shapes or figures. In particular the invention relates to starch-based modeling compounds that may be gluten-free by nature.

### BACKGROUND

Young children play with modeling compounds and sometimes put the modeling compounds into their mouths or ingest the modeling compounds by accident. Because typical modeling compounds are not designed to be ingested, the chemicals present in these compounds may be harmful to the children, causing them to get sick. In addition, many parents these days prefer that their children are exposed to play toys that are free of toxic chemicals because of the tendency to put toys, such as modeling compounds, into their mouths. Moreover, many of these children are allergic to gluten, which is a common ingredient in previous modeling compounds.

Therefore, there exists a need for modeling compounds that are made with food grade ingredients that may be natural, certified organic, made with organic ingredients, and/or gluten-free, for use by children.

### SUMMARY

Embodiments of the present disclosure are generally directed to modeling compounds and methods of making the same. These modeling compounds are made with food grade ingredients and may be natural, certified organic, made with organic ingredients, and/or gluten-free. Modeling compound described herein may be further defined as starch-based modeling compounds. Thus, in some embodiments, a modeling compound comprises a rheology modifier, wherein the modeling compound is gluten-free. For example, the modeling compound may comprise about 2% to about 10% of a rheology modifier. A modeling compound may comprise water, a salt, a gluten-free binder, a hardener, and a rheology modifier. For example, a modeling compound may comprise (a) about 20% to about 55% water; (b) about 5% to about 20% of a salt; (c) about 30% to about 53% of a gluten-free binder; (d) about 0% to about 1% of a hardener; and (e) about 2% to about 10% of a rheology modifier. All percentages herein refer to weight percentages, unless otherwise noted.

### DETAILED DESCRIPTION

Starch-based modeling compounds are known in the art, such as the compositions disclosed in U.S. Pat. Nos. 3,167,440 and 6,713,624, the disclosures of each of which are incorporated herein by reference. The use of a rheology modifier typically affects the characteristics of starch-containing products, such as starch-based modeling compounds. Rheology is the study of the flow of matter, including liquids and soft solids, and is also concerned with the deformation of matter. Rheology modifiers affect rheological properties of materials, such as viscosity, as is known in the art.

During manufacturing of starch-based modeling compounds, rheological properties are exhibited such that modeling compounds are formed that are soft, can stretch, and have an elastic quality. These resulting compounds are easy to manipulate and shape due to their texture and viscosity. However, undesirable rheological properties may also develop during manufacturing, and are usually well advanced in as little as 48 hours, such as significant hardening and increases in viscosity. These properties are undesirable because the hardened compounds are more difficult to manipulate and shape, particularly by young children.

Amylopectin starch is known to be resistant to detrimental rheological effects. However, when amylopectin is mixed with water and heated, it tends to form a paste having a sticky texture, rather than a soft gel, which is typically desired for a modeling compound. A sticky texture in a modeling compound causes the modeling compound to be messy for the user to manipulate, as the compound is more likely to stick to hands, molds, toys, furniture, and carpeting. There is a need for an organic, gluten-free modeling compound that has a soft, flexible texture, low viscosity, is not sticky, has a natural hydrocolloid thickener, and hardens over time.

Accordingly, modeling compounds of the present invention, in general, may comprise water, a salt, a lubricant, a gluten-free binder (that may or may not be soy-free), a preservative, a hardener, a rheology modifier, a humectant, a surfactant, a colorant, an acidulant, or combinations thereof. Any ingredient or combination of ingredients described herein may be optionally excluded, in some embodiments.

Some embodiments of the present invention contemplate a modeling compound comprising a rheology modifier, wherein the modeling compound is gluten-free. The rheology modifier may be present in an amount of about 2% to about 10%. All percentages refer to weight percentages, unless otherwise noted. The rheology modifier may comprise a hydrocolloid. The rheology modifier may comprise a gum or a natural gelling agent. The rheology modifier may be selected from the group consisting of acacia, agar, tapioca, guar, alginates, caragum, carrageenan, pectin, colloids, xanthan gum, gum arabic, inulin, locust bean gum, cellulose, and stabilizers, and any combination thereof.

In some embodiments, a modeling compound comprises (a) about 20% to about 55% water; (b) about 5% to about 20% of a salt; (c) about 30% to about 53% of a gluten-free binder; (d) about 0% to about 1% of a hardener; and (e) about 2% to about 10% of a rheology modifier. All percentages refer to weight percentages, unless otherwise noted. A modeling compound may further comprise about 0% to about 4.5% of a lubricant. The lubricant may be an organic plant-based oil. The lubricant may be olive oil, soy-free vegetable oil, soy-free canola oil, jojoba oil, coconut oil, or palm oil, or any combination thereof. The lubricant may be soy-free. A modeling compound may further comprise about 0% to about 3.5% of a colorant. All percentages refer to weight percentages, unless otherwise noted. A salt may be selected from the group consisting of sodium chloride, calcium chloride, calcium propionate, potassium chloride, and sea salt, and any combination thereof. A gluten-free binder may be selected from the group consisting of corn flour, potato flour, tapioca flour, amaranth flour, arrowroot, sorghum flour, teff flour, chia seed flour, pure buckwheat flour, gram flour, rice flour, millet flour, oat flour, and quinoa flour, and any combination thereof. A gluten-free binder may be a soy-free binder. A hardener may be potassium bitartrate, also known as potassium hydrogen tartrate. As noted above, the rheology modifier may comprise a hydrocolloid, a gum, or a natural gelling agent. The rheology modifier may be selected from the group consisting of acacia, agar, tapioca, guar gum, alginates, carrageenan, pectin, colloids, xanthan gum, gum arabic, inulin, locust bean gum, cellulose, and stabilizers, and any combination thereof. In some embodiments, the rheology modifier is xanthan gum.

A modeling compound may comprise an acidulant, such as potassium bitartrate, also known as potassium hydrogen tartrate. A modeling compound may have a pH ranging from about 3.5 to about 4.5. In some embodiments, the pH ranges from about 3.8 to about 4.0. A modeling compound may further comprise a humectant, such as glycol (e.g., glycerin, such as a vegetable-based glycerin).

In some embodiment, ingredients for a modeling compound include but are not limited to the following: (a) about 20% to about 55% water; (b) about 5% to about 20% of a salt; (c) about 0% to about 4.5% of a lubricant; (d) about 30% to about 53% of a gluten-free binder; (e) about 0% to about 1% of a preservative; (f) about 0% to about 1% of a hardener; (g) about 2% to about 10% of a rheology modifier; (h) 0% to about 25% of a humectant; (i) about 0% to about 4.5% of a surfactant; and/or (j) about 0% to about 3.5% of a colorant. All percentages refer to weight percentages, unless otherwise noted.

In some embodiments, water is present in an amount that is about, at least about, or at most about 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, or 55%, or any range derivable therein. All percentages refer to weight percentages, unless otherwise noted. The water preferably meets the National Primary Drinking Water Specifications (see 40 C.F.R., Ch. 1, Part 141) or the requirements of ASTM F-963, Standard Consumer Safety Specification on Toy Safety, Section 4.3.6.1.

In some embodiments, a salt is present in an amount that is about, at least about, or at most about 5%, 6%, 7%, 8%, 9%, 10%, 11%, 12%, 13%, 14%, 15%, 16%, 17%, 18%, 19%, or 20%, or any range derivable therein. All percentages refer to weight percentages, unless otherwise noted.

In some embodiments, a lubricant is present in an amount that is about, at least about, or at most about 0%, 0.5%, 1%, 1.5%, 2%, 2.5%, 3%, 3.5%, 4%, or 4.5%, or any range derivable therein. All percentages refer to weight percentages, unless otherwise noted.

In some embodiments, a gluten-free binder is present in an amount that is about, at least about, or at most about 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, or 53%, or any range derivable therein. In some embodiments, the range is about 30% to about 48%. All percentages refer to weight percentages, unless otherwise noted.

In some embodiments, a preservative is present in an amount of about, at least about, or at most about 0%, 0.1%, 0.2%, 0.3%, 0.4%, 0.5%, 0.6%, 0.7%, 0.8%, 0.9%, or 1.0%, or any range derivable therein. All percentages refer to weight percentages, unless otherwise noted.

In some embodiments, a hardener is present in an amount of about, at least about, or at most about 0%, 0.1%, 0.2%, 0.3%, 0.4%, 0.5%, 0.6%, 0.7%, 0.8%, 0.9%, or 1.0%, or any range derivable therein. All percentages refer to weight percentages, unless otherwise noted.

In some embodiments, a rheology modifier is present in an amount of about, at least about, or at most about 2%, 2.5%, 3%, 3.5%, 4%, 4.5%, 5%, 5.5%, 6%, 6.5%, 7%, 7.5%, 8%, 8.5%, 9%, 9.5%, or 10%, or any range derivable therein. All percentages refer to weight percentages, unless otherwise noted.

In some embodiments, a humectant is present in an amount of about, at least about, or at most about 0%, 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, or 25%, or any range derivable therein. All percentages refer to weight percentages, unless otherwise noted.

In some embodiments, a surfactant is present in an amount that is about, at least about, or at most about 0%, 0.5%, 1%, 1.5%, 2%, 2.5%, 3%, 3.5%, 4%, or 4.5%, or any range derivable therein. All percentages refer to weight percentages, unless otherwise noted.

The combination of a lubricant and a surfactant typically reduces the stickiness of the modeling compound. A surfactant may be jojoba wax or a non-soy vegetable oil. The lubricant typically has a low enough viscosity so that the modeling compound does not feel slimy to the touch.

In some embodiments, a colorant is present in an amount that is about, at least about, or at most about 0%, 0.5%, 1%, 1.5%, 2%, 2.5%, 3%, or 3.5%, or any range derivable therein. In some embodiments, colorant is present in amount of about 0% to about 2.5%. All percentages refer to weight percentages, unless otherwise noted.

In some embodiments, an acidulant is present in an amount of about, at least about, or at most about 0%, 0.1%, 0.2%, 0.3%, 0.4%, 0.5%, 0.6%, 0.7%, 0.8%, 0.9%, or 1.0%, or any range derivable therein. All percentages refer to weight percentages, unless otherwise noted.

An ingredient may be characterized in more than one way. For example, potassium bitartrate may be used as a hardener, an acidulant, or both, as discussed herein.

It should be appreciated that one or more of the ingredients in a modeling compound may be 100% organic, certified organic, or made with organic ingredients, in accordance to the USDA National Organic Program (NOP) §205.605 and §205.606, and all ingredients are FDA approved or considered food grade.

The rheology modifier may be a hydrocolloid, a gum, a natural suspension, a natural stabilizing agent, or a natural gelling agent, or any mixtures thereof. As non-limiting examples, the rheology modifier may be or include acacia, agar, tapioca, guar gum, alginates (e.g., sodium alginate, potassium alginate, ammonium alginate, calcium alginate), caragum, carrageenan, pectin, colloids, xanthan gum, gum arabic, inulin, locust bean gum, stabilizers (which help stabilize emulsions), and/or any combinations thereof. Cellulose (an organic polysaccharide) may be employed as a thickener, in some embodiments. Various gums and hydrocolloids may be pre-hydrated in some embodiments.

Hydrocolloids are derived from natural sources and include agar-agar, carrageenan, gelatin, and pectin. Gelling agents are food additives used to thicken and stabilize various foods, such as jellies, desserts, and candies. The agents provide the foods with texture through formation of a gel. Some stabilizers and thickening agents are gelling agents. Typical gelling agents include natural gums, starches, pectins, agar-agar, and gelatin. Often they are based on polysaccharides or proteins. Additional non-limiting examples include alginic acid, sodium alginate, potassium alginate, ammonium alginate, calcium alginate, polysaccharides from brown sugar, carrageenan, and locust bean gum.

The salt may include but is not limited to sodium chloride, calcium chloride, calcium propionate, potassium chloride, sea salt, and any mixtures thereof. Iodized salt may be used, such as iodized sodium chloride. The salt typically provides the modeling compound with antimicrobial characteristics. In some embodiments, anti-caking agents are included in modeling compounds described herein. In some embodiments, anti-caking agents are excluded from modeling compounds described herein.

The lubricant may be an oil. As a non-limiting example, the lubricant is a plant-based oil, such as olive oil, soy-free vegetable oil, soy-free canola oil, jojoba oil, coconut oil, palm oil, or vegetable-based glycerin, or combinations thereof. A lubricant may also be mineral spirits or mineral oil.

The binder may be a gluten-free binder, a soy-free binder, or a gluten-free and soy-free binder. Non-limiting examples of binders include corn flour, potato flour, tapioca flour (derived from cassava), amaranth flour, arrowroot, sorghum flour (jowar), teff flour, chia seed flour, pure buckwheat flour, gram flour (derived from chickpeas), rice flour, millet flour, oat flour, quinoa flour, and combinations thereof. In some embodiments, rye flour, tapioca flour, potato flour, or soy (or any combination thereof) is excluded as a binder.

In general, modeling compounds described herein are gluten-free. Regarding the term “gluten-free,” the present invention contemplates this term as referred to by the Gluten-Free Certification Organization. The mark of this Organization assures that the product contains less than 10 ppm gluten (5 ppm gliadin) and similar proteins from rye and barley as measured using testing methods that are accepted for gluten testing by analytical associations such as the Association of Analytical Communities (AOAC), testing researchers, and other such agencies, as known in the art. It is noted that Federal guidelines mandate less than 20 ppm gluten to be characterized as gluten-free.

In some embodiments, modeling compounds are soy-free. Soy (also called soya, soy bean, or glycine max) is among the most common foods that cause allergic reactions: at this time, 15 allergenic proteins have been found in soy. As discussed on the FDA website, “[E]ven low levels of soy protein may cause adverse effects in some sensitive individuals. FDA considers an ‘adverse effect’ to be any objective sign of an allergic reaction. Currently, due to limited data, there is no consensus on the minimal dose of soy protein that will elicit an adverse effect (also referred to as the lowest observed adverse effect level or LOAEL). At least some researchers have suggested, however, that the LOAEL for soy protein appears to be higher than the LOAELs reported for other major allergens, such as milk, egg, and peanuts.” Thus, in some embodiments, a modeling compound excludes soy-derived lecithin, soy flour, soy oils, or any combination thereof.

The preservative may be any preservative as known in the art. A preservative may be a natural extract, or a combination of natural extracts. As non-limiting examples, the preservative may be or include grape extract, citric acid, vinegar, tartaric acid, malic acid, fumaric acid, ascorbic acid and its sodium, potassium, and calcium salts, or antioxidants such as oxygen absorbers, which inhibit the oxidation of food constituents. Common antimicrobial preservatives include calcium propionate, sodium nitrate, sodium nitrite, and sulfites (e.g., sulfur dioxide, sodium bisulfite, potassium hydrogen sulfite). Other preservatives include sodium benzoate, methyl paraben, ethyl paraben, butyl paraben, and borax. Preservatives may be employed that inhibit mold growth at a pH of less than about 4.5.

As a non-limiting example, the hardener may be potassium bitartrate (potassium hydrogen tartrate or cream of tartar).

As non-limiting example, the humectant may be a glycol, such as a glycerin. Vegetable glycerin is generally considered an organic humectant. The humectant may also be another low molecular weight polyethylene glycol.

The colorant may be a food grade natural or synthetic colorant. More particularly, the colorant may be a food grade natural colorant derived from fruits or vegetables, or FD&C synthetic colorants approved by the Food and Drug Administration to be used in the production of food. Combinations of colorants are also contemplated.

The modeling compound may include an acidulant. As non-limiting examples, the acidulant may be vinegar-based, salt-based, or a hardener that may include potassium bitartrate. The acidulant may be citric acid, alum, or potassium dihydrogen sulfate. Nontoxic acids may be employed as acidulants.

The pH of the modeling compound may be acidic. For example, the pH may be in the range of about 3.5 to about 4.5, or about 3.8 to about 4.0. In some embodiments, the pH may be about, at least about, or at most about 3.5, 3.6, 3.7, 3.8, 3.9, 4.0, 4.1, 4.2, 4.3, 4.4, or 4.5, or any range derivable therein. The pH may be adjusted with the addition of, e.g., sodium bicarbonate or sodium hydrogen carbonate.

Methods of making modeling compounds are also contemplated by the present invention. Methods may include, for example, combining dry ingredients (e.g., salt, gluten-free binder, hardener, acidulant, rheology modifier) and mixing, followed by addition of preheated water (e.g., 130-212° F.), which may contain colorant, followed by further mixing, optionally adding humectant, lubricant, surfactant, and/or colorant at this point, followed by further mixing, and then removing the fully compounded modeling compound from the mixer.

In accordance with embodiments of the present disclosure, exemplary recipes for various different colors of modeling compounds (with components provided in weight percentages) are provided in TABLES 1-5 below, where the colorants used are provided in TABLE 6. All components were food grade. In variations of these Examples, each percentage may be rounded to the nearest tenth of a percent or to the nearest whole number.

TABLE 1

| | rice | sea | xanthan | | cream of | |
|---|---|---|---|---|---|---|
| | flour | salt | gum | water | tartar | colorant |
| | (wt %) | (wt %) | (wt %) | (wt %) | (wt %) | (wt %) |
| natural | 41.8 | 15.11 | 1.70 | 40.68 | 0.71 | 0.00 |
| brown | 41.8 | 15.11 | 1.70 | 39.86 | 0.71 | 0.82 |
| yellow | 41.8 | 15.11 | 1.70 | 40.42 | 0.71 | 0.27 |
| purple | 41.8 | 15.11 | 1.70 | 39.59 | 0.71 | 1.10 |
| light blue | 41.8 | 15.11 | 1.70 | 40.14 | 0.71 | 0.55 |
| indigo | 41.8 | 15.11 | 1.70 | 39.59 | 0.71 | 1.10 |
| orange | 41.8 | 15.11 | 1.70 | 40.00 | 0.71 | 0.68 |
| red | 41.8 | 15.11 | 1.70 | 39.04 | 0.71 | 1.65 |
| green | 41.8 | 15.11 | 1.70 | 40.14 | 0.71 | 0.55 |
| black | 41.8 | 15.11 | 1.70 | 39.04 | 0.71 | 1.63 |

TABLE 2

| | rice | sea | xanthan | | cream of | | jojoba |
|---|---|---|---|---|---|---|---|
| | flour | salt | gum | water | tartar | colorant | oil |
| | (wt %) | (wt %) | (wt %) | (wt %) | (wt %) | (wt %) | (wt %) |
| natural | 41.8 | 15.11 | 1.70 | 39.01 | 0.71 | 0.00 | 1.67 |
| brown | 41.8 | 15.11 | 1.70 | 36.5 | 0.71 | 2.51 | 1.67 |
| yellow | 41.8 | 15.11 | 1.70 | 38.74 | 0.71 | 0.27 | 1.67 |
| purple | 41.8 | 15.11 | 1.70 | 37.91 | 0.71 | 1.10 | 1.67 |
| blue | 41.8 | 15.11 | 1.70 | 39.59 | 0.71 | 0.175 | 1.67 |
| orange | 41.8 | 15.11 | 1.70 | 38.33 | 0.71 | 0.68 | 1.67 |
| red | 41.8 | 15.11 | 1.70 | 37.37 | 0.71 | 1.97 | 1.67 |
| green | 41.8 | 15.11 | 1.70 | 30.46 | 0.71 | 0.17 | 1.67 |

TABLE 3

| | rice | | | | cream of | |
|---|---|---|---|---|---|---|
| | flour | salt* | agar | water | tartar | colorant |
| | (wt %) | (wt %) | (wt %) | (wt %) | (wt %) | (wt %) |
| natural | 41 | 15.4 | 1.75 | 41 | 0.85 | 0.00 |
| brown | 41 | 15.4 | 1.75 | 38.49 | 0.85 | 2.51 |
| yellow | 41 | 15.4 | 1.75 | 40.73 | 0.85 | 0.27 |
| purple | 41 | 15.4 | 1.75 | 39.90 | 0.85 | 1.10 |
| blue | 41 | 15.4 | 1.75 | 40.825 | 0.85 | 0.175 |
| orange | 41 | 15.4 | 1.75 | 40.32 | 0.85 | 0.68 |
| red | 41 | 15.4 | 1.75 | 39.03 | 0.85 | 1.97 |
| green | 41 | 15.4 | 1.75 | 40.83 | 0.85 | 0.17 |

*For example, NaCl, or iodized NaCl, or iodized NaCl with an anti-caking agent.

TABLE 4

| | rice | | hydro- | | cream of | | non-soy |
|---|---|---|---|---|---|---|---|
| | flour | salt* | colloid** | water | tartar | colorant | vegetable |
| | (wt %) | (wt %) | (wt %) | (wt %) | (wt %) | (wt %) | oil (wt %) |
| natural | 41 | 15.4 | 1.75 | 39.33 | 0.85 | 0.00 | 1.67 |
| brown | 41 | 15.4 | 1.75 | 36.82 | 0.85 | 2.51 | 1.67 |
| yellow | 41 | 15.4 | 1.75 | 39.06 | 0.85 | 0.27 | 1.67 |
| purple | 41 | 15.4 | 1.75 | 38.23 | 0.85 | 1.10 | 1.67 |
| blue | 41 | 15.4 | 1.75 | 39.155 | 0.85 | 0.175 | 1.67 |
| orange | 41 | 15.4 | 1.75 | 38.65 | 0.85 | 0.68 | 1.67 |
| red | 41 | 15.4 | 1.75 | 37.36 | 0.85 | 1.97 | 1.67 |
| green | 41 | 15.4 | 1.75 | 39.16 | 0.85 | 0.17 | 1.67 |

*For example, NaCl, or iodized NaCl, or iodized NaCl with an anti-caking agent.
**For example, carrageenan gum

TABLE 5

| | rice | sea | | | cream of | | vegetable |
|---|---|---|---|---|---|---|---|
| | flour | salt | agar | water | tartar | colorant | glycerin |
| | (wt %) | (wt %) | (wt %) | (wt %) | (wt %) | (wt %) | (wt %) |
| natural | 41 | 15.4 | 1.75 | 39.33 | 0.85 | 0.00 | 1.67 |
| brown | 41 | 15.4 | 1.75 | 36.82 | 0.85 | 2.51 | 1.67 |
| yellow | 41 | 15.4 | 1.75 | 39.06 | 0.85 | 0.27 | 1.67 |
| purple | 41 | 15.4 | 1.75 | 38.23 | 0.85 | 1.10 | 1.67 |
| blue | 41 | 15.4 | 1.75 | 39.155 | 0.85 | 0.175 | 1.67 |
| orange | 41 | 15.4 | 1.75 | 38.65 | 0.85 | 0.68 | 1.67 |
| red | 41 | 15.4 | 1.75 | 37.36 | 0.85 | 1.97 | 1.67 |
| green | 41 | 15.4 | 1.75 | 39.16 | 0.85 | 0.17 | 1.67 |

TABLE 6

| CAS Number | Ingredient |
|---|---|
| 1390-65-5 | Red #3945 |
| 1393-63-1 | Orange #3946 |
| 458-37-7 | Yellow #3944 |
| 528-58-5 | Blue #3947 |
| 8028-89-5 | Organic Caramel #7812 |
| 8028-89-5 + 528-58-5 | Black #3950 |
| 8028-89-5 | Brown #3954B |
| 458-37-7 + 528-58-5 | Green #3948 |

Modeling compounds as described herein are surprisingly resilient and have a soft, flexible texture that is low in viscosity and stickiness. Unexpectedly, combining a starch, such as rice flour, with a rheology modifier, such as a hydrocolloid, produces a composition that is resistant to free flow and movement, yet does not have a sticky, pasty texture that is typically obtained when hydrocolloids are mixed with water and heated. The modeling compound has a soft, flexible, elastic texture, low viscosity and stickiness, and resistance to flow, which makes the compound easier to use for molding, extruding, or sculpting shapes or figures, particularly by young children who typically use modeling compounds.

Of course, if working with the compound in a kitchen setting or around food, the compound should be protected from cross-contamination.

Proper storage of the modeling compound is also recommended. Such conditions include a tightly sealed container that is out of direct sunlight and away from high heat and flames.

A modeling compound may be rewetted, if needed. Exemplary procedures for rewetting are provided below.

It is contemplated that any embodiment discussed in this specification can be implemented with respect to any method, material, or composition of the invention, and vice versa. Furthermore, compounds and compositions of the invention can be used to achieve methods of the invention.

The use of the term “or” in the claims is used to mean “and/or” unless explicitly indicated to refer to alternatives only or the alternatives are mutually exclusive, although the disclosure supports a definition that refers to only alternatives and “and/or.”

Throughout this application, the term “about” is used to indicate that a value includes the standard deviation of error for the device or method being employed to determine the value. In any embodiment discussed in the context of a numerical value used in conjunction with the term “about,” it is specifically contemplated that the term “about” can be omitted.

Following long-standing patent law, the words “a” and “an,” when used in conjunction with the word “comprising” in the claims or specification, denotes one or more, unless specifically noted.

### EXAMPLES

### Example 1

### Preparation of a Modeling Compound

In accordance with embodiments of the present disclosure, a composition was prepared according to the following procedure using ingredients as described in Table 1. Alternative ingredients as described herein may be substituted for the ingredients used in this Example.

1. All of the dry ingredients (e.g., the salt, gluten-free binder, hardener, and rheology modifier) were added to a mixer (e.g., a vertical or spiral batch mixer).

2. The mixer was turned on and set on medium speed.

3. After 2 minutes, water containing colorant, preheated to a temperature of about 170-212° F., was added to the mixture.

4. The batch was mixed for an additional 5 minutes.

5. The fully compounded modeling compound was dispatched from the mixer.

### Example 2

### Preparation of a Modeling Compound

In accordance with embodiments of the present disclosure, a composition was prepared according to the following procedure using ingredients as described in Table 2.

Alternative ingredients as described herein may be substituted for the ingredients used in this Example.

1. All of the dry ingredients (e.g., the salt, gluten-free binder, hardener, and rheology modifier) were added to a mixer (e.g., a vertical or spiral batch mixer).

2. The mixer was turned on and set on low speed and mixed for 1 minute.

3. Water, preheated to a temperature of about 170-212° F., was added to the mixture. Colorant was optionally added at this time or added in step 5.

4. With the mixer on medium speed, the batch was mixed for an additional 2½ minutes.

5. With the mixer running on low speed, lubricant and, optionally, colorant were added, mixing until incorporated.

6. Mixing of the batch was continued on medium speed for 5 minutes.

7. The fully compounded modeling compound was dispatched from the mixer.

### Example 3

### Preparation of a Modeling Compound with Prehydrated Xanthan Gum

In accordance with embodiments of the present disclosure, a composition was prepared according to the following procedure using ingredients as described in Table 2:

1. All of the dry ingredients (e.g., the salt, gluten-free binder, hardener, and rheology modifier) were added to a mixer (e.g., a vertical or spiral batch mixer).

2. The mixer was turned on and set on low speed and mixed for 1 minute.

3. Water was preheated to a temperature of about 130-170° F. Prehydrated rheology modifier was sprinkled into the water. This water mixture was slowly added to the dry ingredients. Color can be added at this time or wait until step 5.

4. With the mixer on medium speed, the batch was mixed for an additional 3 minutes.

5. With the mixer running on low speed, lubricant and, optionally, colorant were added, mixing until incorporated.

6. Mixing of the batch was continued on medium speed for 7 minutes.

7. The fully compounded modeling compound was dispatched from the mixer.

### Example 4

### Preparation of a Modeling Compound in Steam Jacketed Mixer

In accordance with embodiments of the present disclosure, a composition was prepared according to the following procedure using ingredients as described in Table 2. Alternative ingredients as described herein may be substituted for the ingredients used in this Example.

1. All of the dry ingredients (e.g., the salt, gluten-free binder, hardener, and rheology modifier) were added to a steam jacketed batch mixer.

2. The mixer temperature was turned off and the speed was set to low speed, where mixing took place for 1 minute.

3. Water was added and mixed in the heated mixer until the temperature reached about 130-160° F.

4. On medium speed with the temperature turned off, the batch was mixed for an additional 2½ minutes.

5. With the mixer running on low speed with the temperature turned off, lubricant and colorant were added, mixing until incorporated.

6. Mixing of the batch continued on medium speed with the temperature turned off for 5 minutes.

7. The fully compounded modeling compound was dispatched from the mixer.

### Example 5

### Re-Moistening of a Modeling Compound

In accordance with embodiments of the present disclosure, a composition was rewetted or remoistened according to the following procedure. For example, should salt crystals rise to the surface of a modeling compound, such as after purchase, the compound may be revived using either of these steps.

1. The exterior of the compound was wetted, and the compound was kneaded or reworked on a firm surface or counter until the original texture was achieved.

2. Alternately, the exterior of the compound was wetted and placed back in the original or similar container and allowed to sit for 1-24 hours before being reworked, until the original texture was achieved.

While the compositions and methods of this invention have been described in terms of preferred embodiments, it will be apparent to those of skill in the art that variations may be applied to the methods and apparatuses and in the steps or in the sequence of steps of the methods described herein without departing from the concept, spirit and scope of the invention.

The embodiments of the invention in which an exclusive property or privilege is claimed are defined as follows:

1. A modeling compound comprising a rheology modifier, wherein the modeling compound is gluten-free.

2. The modeling compound of claim 1, wherein the rheology modifier comprises a hydrocolloid.

3. The modeling compound of claim 1, wherein the rheology modifier comprises a gum or natural gelling agent.

4. The modeling compound of claim 1, wherein the rheology modifier is selected from the group consisting of acacia, agar, tapioca, guar, alginates, caragum, carrageenan, pectin, colloids, xanthan gum, gum arabic, inulin, locust bean gum, cellulose, and stabilizers, and any combination thereof.

5. A modeling compound comprising water, a salt, a gluten-free binder, a hardener, and a rheology modifier.

6. The modeling compound of claim 5, further comprising a lubricant.

7. The modeling compound of claim 6, wherein the lubricant is an organic plant-based oil.

8. The modeling compound of claim 7, wherein the lubricant is olive oil, soy-free vegetable oil, soy-free canola oil, jojoba oil, coconut oil, or palm oil, or any combination thereof.

9. The modeling compound of claim 6, wherein the lubricant is soy-free.

10. The compound of claim 5, further comprising a colorant.

11. The modeling compound of claim 5, wherein the salt is selected from the group consisting of sodium chloride, calcium chloride, calcium propionate, potassium chloride, and sea salt, and any combination thereof.

12. The modeling compound of claim 5, wherein the gluten-free binder is selected from the group consisting of corn flour, potato flour, tapioca flour, amaranth flour, arrowroot, sorghum flour, teff flour, chia seed flour, pure buckwheat flour, gram flour, rice flour, millet flour, oat flour, and quinoa flour, and any combination thereof.

13. The modeling compound of claim 5, wherein the gluten-free binder is also a soy-free binder.

14. The modeling compound of claim 5, wherein the hardener is potassium bitartrate, also known as potassium hydrogen tartrate.

15. The modeling compound of claim 5, wherein the rheology modifier comprises a hydrocolloid.

16. The modeling compound of claim 5, wherein the rheology modifier comprises a gum or natural jelling agent.

17. The modeling compound of claim 5, wherein the rheology modifier is selected from the group consisting of acacia, agar, tapioca, guar gum, alginates, carrageenan, pectin, colloids, xanthan gum, gum arabic, inulin, locust bean gum, cellulose, and stabilizers, and any combination thereof.

18. The modeling compound of claim 5, further comprising an acidulant.

19. The modeling compound of claim 5, having a pH of about 3.5 to about 4.5.

20. The modeling compound of claim 5, further comprising a humectant.
